(19) United States
(12) Patent Application Publication
(10) Pub. No.: US 2003/0235810 A1
(43) Pub. Date: Dec. 25, 2003

(54) Terminal operation training apparatus

(75) Inventors: Toshihiro Ide, Fukuoka (JP); Hideo Ueno, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/453,886

(22) Filed: Jun. 4, 2003

(30) Foreign Application Priority Data
Jun. 6, 2002 (JP) 2002-165354

(51) Int. Cl. G09B 3/00

(52) U.S. Cl. 434/350; 434/362

(57) ABSTRACT

The present invention provides a terminal operation training apparatus for supporting operation training of an operator terminal apparatus for use in receiving customers. The apparatus stores operation data representing a valid or invalid operation procedure of the operator terminal apparatus, and displays an operation screen of the operator terminal apparatus. The apparatus then compares operations input from a learner with the operation data, inspects validity of the operations, and transmits an inspection result to a supervisor terminal apparatus via a communication line. The supervisor terminal apparatus displays the inspection result.

### FIELD OF THE INVENTION

The present invention relates to a terminal operation training apparatus for supporting training for terminal operation of an operator terminal apparatus for use in receiving customers, and a terminal operation training system and a terminal operation training method therefor. The present invention also relates to a supervisor terminal apparatus for supervising conditions of the terminal operation training apparatus.

### BACKGROUND OF THE INVENTION

As one of the typical systems having an operator terminal apparatus operated by an operator, there is prepared a call center system for receiving telephone calls from customers.

In recent years, it has been required to improve services by promptly receiving telephone inquiries from product purchasers, etc., or to achieve increased efficiency in receiving product orders by telephone from customers who want to purchase products. For such purposes, a growing number of enterprises have installed such call center systems.

FIG. 24 is a block diagram showing a schematic configuration of a conventional call center system 100. Call center system 100 has n operator terminal apparatuses (n is an integer of one or more) 200₁-200ₙ, a PBX 600, a supervisor terminal apparatus 300, a database server 500, and a local area network (LAN) 400.

Each of the operator terminal apparatus 200₁-200ₙ is a terminal apparatus operated by an operator who receives customers. The supervisor terminal apparatus 300 is a terminal apparatus mainly operated by a supervisor who supervises the operators. Operator terminal apparatuses 200₁-200ₙ (hereinafter generically referred to as operator terminal apparatus 200) are constituted of an identical configuration including a computer, a handset, and an interface unit, which are not shown, interfacing the PBX.

On the other side, operator terminal apparatus 200 and supervisor terminal apparatus 300 are connected to LAN 400 provided in the call center system. These terminal apparatuses are able to communicate mutually through LAN 400. Further, database server 500 is connected to LAN 400. Operator terminal apparatus 200 and supervise terminal apparatus 300 can store data in database server 500, and read the data which have been stored therein.

An operator receives customers by operating operator terminal apparatus 200. A supervisor supervises each operator using supervisor terminal apparatus 300, and trains the operators.

In order that call center system 100 be operated efficiently, prompt terminal operation is required for each operator. Generally, operator terminal apparatus 200 is structured with an operation system design for an expert performing efficient operation. As a result, it is not easy for a beginner to use operator terminal apparatus 200. For this reason, it becomes important to consider terminal operation training especially in an introductory training for beginners, as well as operational support in an early job stage of such beginners. These introductory training and operational support become particularly important under the circumstances that a large number of operators frequently quit and other new operators join in place of them.

The introductory training for beginners is conducted through the following procedure.

(1) A supervisor operates operator terminal apparatus 200 by remotely operating from supervisor terminal apparatus 300, so as to show an operator how the operation should be carried out;

(2) The supervisor instructs the operator on the important operational points;

(3) operator terminal apparatus 200 displays guidance to lead the operator while the operator is actually operating operator terminal apparatus 200; and

(4) The operator actually operates operator terminal apparatus 200 without such guidance. The supervisor watches the operator's operation either through supervisor terminal apparatus 300 or by going around on the spot, scores the operator's operation, and instructs the operator.

Further, during operational support in the actual job, supervisor terminal apparatus 300 monitors operator terminal apparatus 200. When necessary, supervisor terminal apparatus 300 performs remote operation against operator terminal apparatus 200 and guides the operator in the operation.

However, in the conventional introductory training, particularly in the stage described in above (4), it is necessary for the supervisor to watch only one operator at a time, which impedes efficiency in the training. Further, when training a multiple of operators, the supervisor often fails to grasp the progress state of learning for each operator, which makes it difficult to conduct efficient training. Moreover, in order to grasp the progress state of learning easily for each operator, it is necessary that the supervisor watch only one operator after all. This has impeded efficiency in the training.

In addition, because normally an experienced operator acts a role of supervisor, a valuable human resource of experienced operators has been restrained, and also a rate of the call center system operation has been degraded.

In the conventional operational support, it is also difficult for the supervisor to identify an exact operator having performed an operation not conforming to the operation rule, which also impedes efficiency of operational support.

### SUMMARY OF THE INVENTION

It is an object of the present invention to provide efficient terminal operation training with respect to an operator terminal apparatus so as to solve the aforementioned problems.

In accordance with a first aspect of the present invention to achieve the above-mentioned object, there is provided a terminal operation training apparatus for supporting operation training of an operator terminal apparatus for use in receiving customers. The terminal operation training apparatus comprises: a storage unit, which stores operation data representing a valid or invalid operation procedure of the operator terminal apparatus; a display unit, which displays an operation screen of the operator terminal apparatus; an input unit, which inputs operations of a learner corresponding to said operation screen; an operation inspection unit, which compares the operations input through said input unit with the operation data and inspects validity of the operations; and a transmission unit, which transmits an inspection result obtained by said operation inspection unit to a supervisor terminal apparatus which is connected to the terminal operation training apparatus through a communication line.

A terminal operation training method according to the first aspect of the present invention is a method performed in a terminal operation training apparatus for supporting operation training of an operator terminal apparatus for use in receiving customers, said terminal operation training method comprising: displaying an operation screen of the operator terminal apparatus onto a display unit of the terminal operation training apparatus; receiving an operation input corresponding to the operation screen, said operation input being input by a learner; inspecting validity of the operation input by comparing the received operation input with an operation data representing a valid or invalid operation procedure of the operator terminal apparatus, said operation data being stored in a storage unit of the terminal operation training apparatus; and transmitting the inspection result to an apparatus of a supervisor connected to the terminal operation training apparatus.

There is also provided a program product according to the first aspect of the present invention, said program product making a computer execute said terminal operation training method.

According to the first aspect of the present invention, the validity of the operation input from the learner is inspected by the operation inspection unit, in which the operation input from the learner corresponding to the operation screen is compared with the operation data. The inspection result is then transmitted to the supervisor terminal apparatus by the transmission unit. Thus, the supervisor can identify the validity of the operation input from the learner without need of the supervisor's decision on the validity of the operation. This enables the supervisor to grasp the learning state of progress of the learner, the points which the learner is apt to mistake, and the like. As a result, training efficiency by the supervisor can be improved, and efficient training can be performed.

In accordance with a second aspect of the present invention, there is provided a supervisor terminal apparatus for supervising a state of a terminal operation training apparatus used by a learner so as to support operation training of an operator terminal apparatus for use in receiving customers, said supervisor terminal apparatus being connected via a communication line to the terminal operation training apparatus. The supervisor terminal apparatus comprises: a reception unit, which receives, from the terminal operation training apparatus through the communication line, an inspection result including validity of an operation input by the learner in the terminal operation training apparatus, said validity being obtained by comparing the operation input with an operation data representing a valid or invalid operation procedure of the operator terminal apparatus; and a display unit, which displays the inspection result received by the reception unit.

A supervising method according to the second aspect of the present invention is a method performed in a supervisor terminal apparatus for supervising a state of a terminal operation training apparatus used by a learner so as to support operation training of an operator terminal apparatus for use in receiving customers, said supervisor terminal apparatus being connected via a communication line to the terminal operation training apparatus, said supervising method comprising: receiving, from the terminal operation training apparatus through the communication line, an inspection result including validity of an operation input by a learner in terminal operation training apparatus, said validity being obtained by comparing the operation input with an operation data representing a valid or invalid operation procedure of the operator terminal apparatus; and displaying the inspection result onto a display unit of said supervisor terminal apparatus.

According to the second aspect of the present invention, the inspection result is instructed by displaying onto a display unit of the supervisor terminal apparatus. The inspection result includes the validity of the operation input obtained by comparing the operation input by a learner from the terminal operation training apparatus with an operation data representing a valid or invalid operation procedure of the operator terminal apparatus. Thus, the supervisor can identify the validity of the operation input from the learner without need of the supervisor's decision on the validity of the operation. This enables the supervisor to grasp the learner's learning state of progress, the points which the learner is apt to mistake, and the like. As a result, training efficiency by the supervisor can be improved, and efficient training can be performed.

In accordance with a third aspect of the present invention, there is provided a terminal operation training system having a terminal operation training apparatus and a supervisor terminal apparatus, said terminal operation training apparatus supporting operation training of an operator terminal apparatus for use in receiving customers, said supervisor terminal apparatus supervising said terminal operation training apparatus. The terminal operation training apparatus comprises: a storage unit, which stores operation data representing a valid or invalid operation procedure of the operator terminal apparatus; a display unit, which displays an operation screen of the operator terminal apparatus; an input unit, which inputs operations of a learner corresponding to the operation screen; an operation inspection unit, which compares the operations input through said input unit with the operation data and inspects validity of the operations; and a transmission unit, which transmits an inspection result obtained by said operation inspection unit to the supervisor terminal apparatus connected to said terminal operation training apparatus through a communication line. The supervisor terminal apparatus comprises: a reception unit, which receives the inspection result transmitted from the transmission unit through the communication line; and a display unit, which displays the inspection result received by the reception unit.

According to the third aspect of the present invention, similar functions and effects obtained in the first and second aspects of the present invention are obtainable.

Further scopes and features of the present invention will become more apparent by the following description of the embodiments with the accompanied drawings.

### BRIEF DESCRIPTION OF THE DRAWINGS

FIG. 1 shows a block diagram illustrating an overall configuration of a call center system according to one embodiment of the present invention;

FIG. 2 shows a functional block diagram illustrating detailed functions of an operator terminal apparatus and a supervisor terminal apparatus:

FIG. 3 shows an example of a curriculum data;

FIG. 4 shows an example of an operation data;

FIG. 5 shows an example of a curriculum data;

FIG. 6 shows an example of an operation data;

FIG. 7 shows a flowchart illustrating an overall processing flow of the operator terminal apparatus;

FIG. 8 shows a flowchart illustrating an overall processing flow of the supervisor terminal apparatus;

FIGS. 9 and 10 show a flowchart illustrating learning/training support processing of the operator terminal apparatus in an introductory training mode;

FIGS. 11 and 12 show a flowchart illustrating learning/training support processing of the operator terminal apparatus in a practical job mode;

FIGS. 13 and 14 show a flowchart illustrating learning/training support processing of the operator terminal apparatus in an individual learning mode;

FIG. 15 shows a processing menu screen of the operator terminal apparatus;

FIG. 16 shows a main screen of the operator terminal apparatus;

FIG. 17 shows a curriculum selection screen displayed on the operator terminal apparatus;

FIG. 18 shows a hint screen displayed on the operator terminal apparatus;

FIG. 19 shows a screen of the operator terminal apparatus at the time of remote operation;

FIG. 20 shows a main screen of the supervisor terminal apparatus;

FIG. 21 shows a curriculum selection screen displayed on the supervisor terminal apparatus;

FIG. 22 shows an operation condition of an operator displayed on the supervisor terminal apparatus;

FIG. 23 shows a main screen of the operator terminal apparatus displayed on the supervisor terminal apparatus; and

FIG. 24 is a block diagram showing a schematic configuration of a conventional call center system.

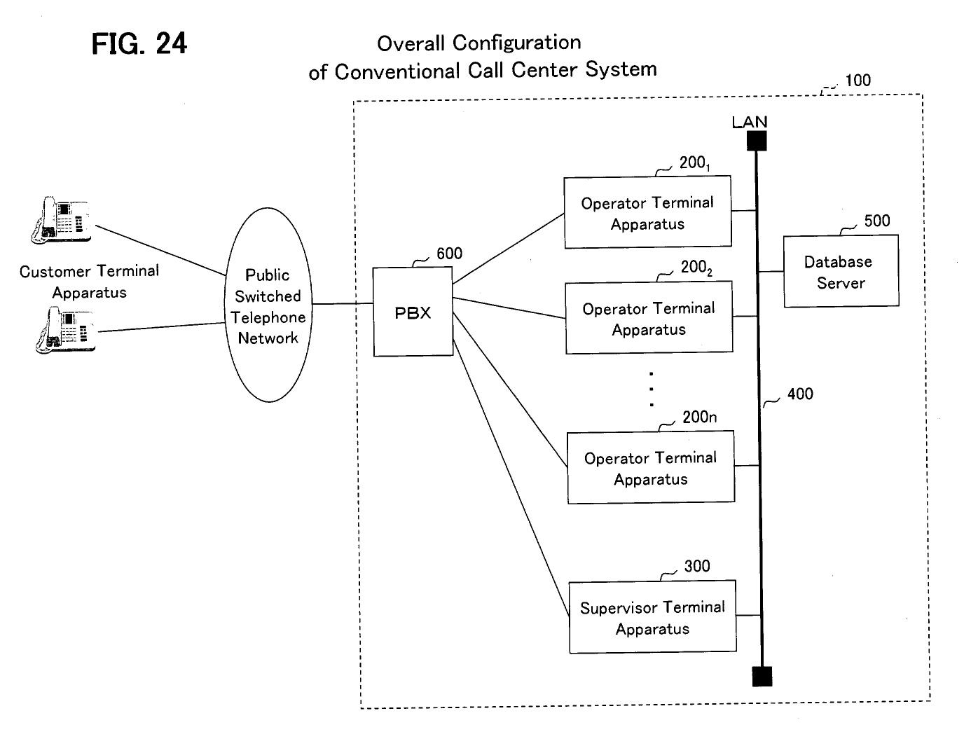

### DETAILED DESCRIPTION OF THE PREFERRED EMBODIMENTS

The preferred embodiment of the present invention is described hereinafter referring to the charts and drawings. In the following description, a call center system is shown as one embodiment of the present invention, in which an operator terminal apparatus and a supervisor terminal apparatus disposed in the call center system are illustrated. However, it is to be noted that the scope of the present invention is not limited to the embodiment described below.

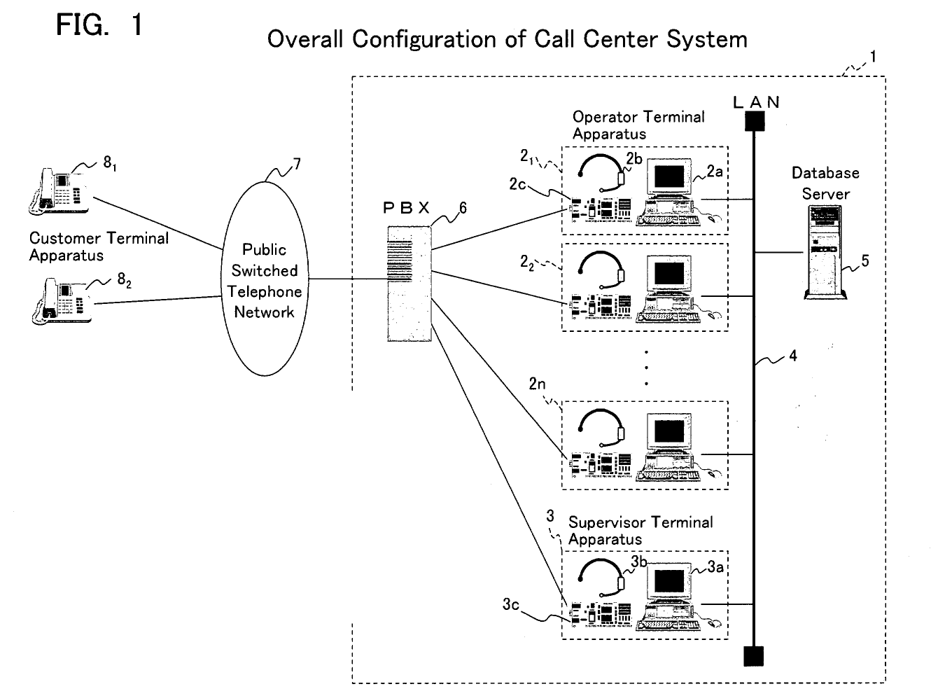

FIG. 1 shows a block diagram illustrating an overall configuration of a call center system 1 in accordance with an embodiment of the present invention. The call center system 1 includes n operator terminal apparatuses (n is an integer of one or more) 2₁-2ₙ, a supervisor terminal apparatus 3, a local area network (LAN) 4, a database server 5, and a PBX 6.

PBX 6 is connected to a public switched telephone network 7. PBX 6 distributes calls incoming through public switched telephone network 7 from customer terminal apparatuses (telephone sets) 8₁-8ₙ for the customers' use (hereafter generically referred to as customer terminal apparatuses 8) by use of the ACD (automatic call distribution) facility to operator terminal apparatuses 2₁-2ₙ. PBX 6 also transmits calls originating from operator terminal apparatuses to customer terminal apparatuses of the opposite communication parties through public switched telephone network 7.

Operator terminal apparatuses 2₁-2ₙ are terminal apparatuses operated by each operator who receives customers. Operator terminal apparatuses 2₁-2ₙ are structured of identical configuration. Therefore, hereafter, operator terminal apparatuses 2₁-2ₙ are representatively referred to as an operator terminal apparatus 2, unless it is necessary to distinguish each operator terminal apparatus particularly.

Supervisor terminal apparatus 3 is a terminal apparatus mainly operated by a supervisor who supervises the operators. Supervisor terminal apparatus 3 can function as an operator terminal apparatus. In addition to supervisory job including training of the operators, there may be cases that the supervisor may conduct an operator's job.

Operator terminal apparatus 2 includes a computer 2a, a handset 2b, and an interface unit 2c for interface the PBX. Handset 2b is connected to computer 2a, and includes a speaker (headphone, earphone, or the like) and a microphone for use in voice communication through the telephone. Interface unit 2c includes a hardware circuit to provide computer 2a with the telephone function, through which voice signals received from customer terminal apparatus 8 are output to the speaker provided in handset 2b, and voice signals received from the microphone in handset 2b are transmitted to customer terminal apparatus 8. Further, interface unit 2c has such functions as supplying to computer 2a incoming call information and telephone number of the originating party, and displaying such received information and the like onto a display unit (CRT display, liquid crystal display, etc.) provided in computer 2a.

Supervisor terminal apparatus 3 also includes computer 3a, handset 3b, and interface unit 3c, similarly to operator terminal apparatus 2. Handset 3b and interface unit 3c respectively have the same functions as handset 2b and interface 2c.

On the other side, operator terminal apparatus 2 and supervisor terminal apparatus 3 are connected to LAN 4 provided in call center system 1, through which it is possible to communicate with each other. LAN 4 is also connected to database server 5. Operator terminal apparatus 2 and supervisor terminal apparatus 3 can store data in database server 5, and also can read out the stored data.

In database server 5, there is stored operator information which includes a registered operator number (operator No.), an operator's name (such as a full name), and a password. When using operator terminal apparatus 2, each operator inputs the operator number, the operator's name, and the password of the operator's own. Such input information is transmitted to database server 5 through LAN 4. Database server 5 authenticates the operator based on the information transmitted from terminal apparatus 2 and the stored operator information.

Database server 5 also stores customer information for customers who made incoming calls in the past. The customer information includes a unique identification number assigned to each customer (customer number, or customer No.), customer name, address, telephone number, and the like. By the use of operator terminal apparatus 2, the operator inputs, for example, customer number, customer name, etc. into operator terminal apparatus 2, and thus the operator can obtain customer information related to the incoming calls in the past from database server 5.

Similarly, supervisor's number, his or her name, and password are stored in database server 5. The supervisor inputs such information into supervisor terminal apparatus 3, and database server 5 performs authentication also to the supervisor.

This call center system 1 has a function of supporting the operators in learning terminal operation or training, in addition to the telephoning function on receiving customers. This learning support or training support (hereafter referred to as learning/training support) includes the following three modes: introductory training mode, practical job mode, and individual learning mode.

In the introductory training mode, the learning/training support is performed during introductory training for the operators. In the practical job mode, the learning/training support is performed during actual job in which the operator actually receives a customer. In the individual learning mode, the learning/training support is performed when the operator is learning the terminal operation without communicating with customers or supervisor terminal apparatus 3.

In each mode of the introductory training mode and the individual learning mode, there are further provided three types of learning/training support modes. In a first mode, the learning/training support is performed for the operator by giving an exemplary operation visually to the operator. In this first mode, the operator learns the operation by looking at the display unit of operator terminal apparatus 2 without operating operator terminal apparatus 2. Ina second mode, operator terminal apparatus 2 guides the operator and makes the operator operate actually. In this second mode, operator terminal apparatus 2 guides the operator by displaying a button to be clicked next or a data to be input next. The operator then clicks the button or inputs the data according to the displayed guidance. In a third mode, the guidance displayed in the second mode is not displayed. Instead, the operator performs operation corresponding to a specified curriculum in the substantially same way as will be performed in the practical job.

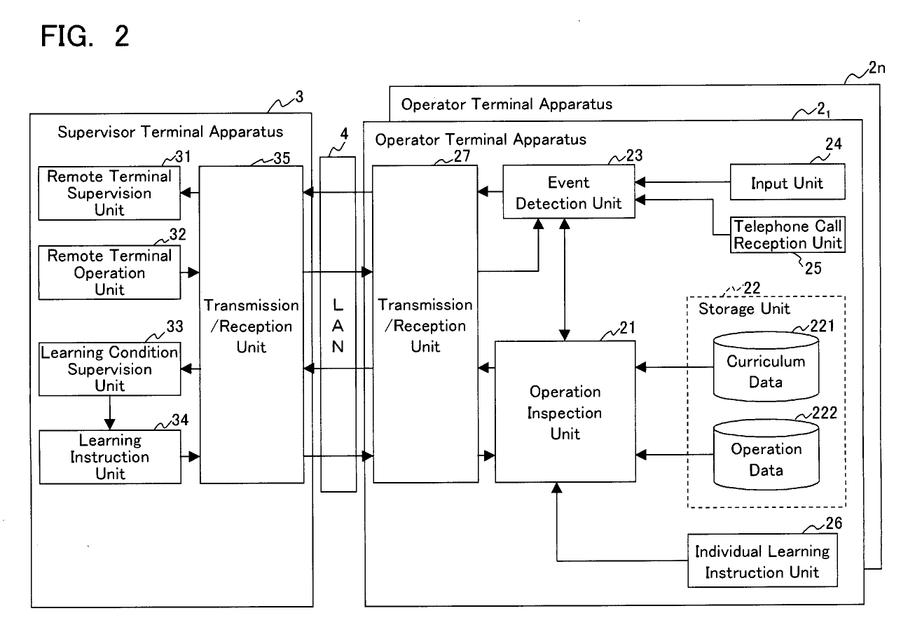

FIG. 2 is a functional block diagram illustrating detailed function configurations of operator terminal apparatus 2 and supervisor terminal apparatus 3. In this functional block diagram, only a portion of executing processing related to the learning/training support is shown, and a portion of executing communication processing for the operator to communicate with customers is omitted.

Operator terminal apparatus 2 includes an operation inspection unit 21, a storage unit 22, an event detection unit 23, an input unit 24, a telephone call reception unit 25, an individual learning instruction unit 26, and a transmission/reception unit 27. Supervisor terminal apparatus 3 is constituted of a remote terminal supervision unit 31, a remote terminal operation unit 32, a learning condition supervision unit 33, a learning instruction unit 34, and a transmission/reception unit 35.

Transmission/reception units 27, 35 perform communication processing (processing of the communication protocol) with LAN 4, and transmit or receive data through LAN 4.

Storage unit 22 is, for example, a hard disk provided in computer 2a, and stores curriculum data 221, operation data 222, and screen data (not shown in FIG. 2) for a main screen, etc. described later. Curriculum data 221 are program data (script program data) respectively corresponding to a plurality of terminal operation curriculum types. Computer 2a executes these script programs to perform the learning/training support. Operation data 222 are data to be executed by execution instructions (EXECUTE) included in the script programs, and includes operation procedure strings to be executed by the operator. Operation data 222 are used also for determining whether the operation performed by the operator is right or wrong.

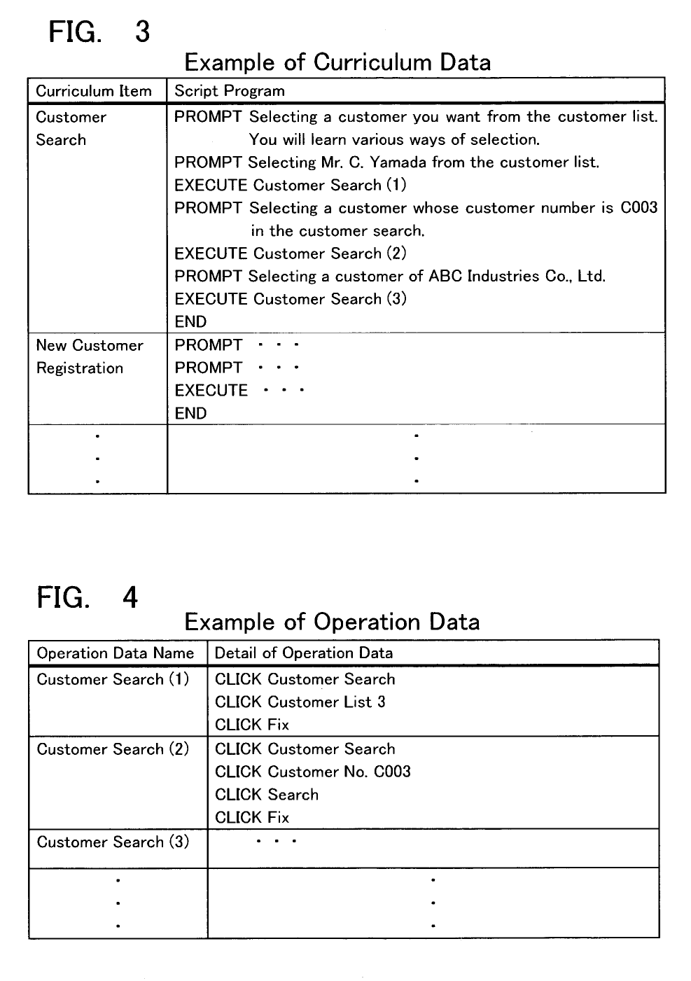

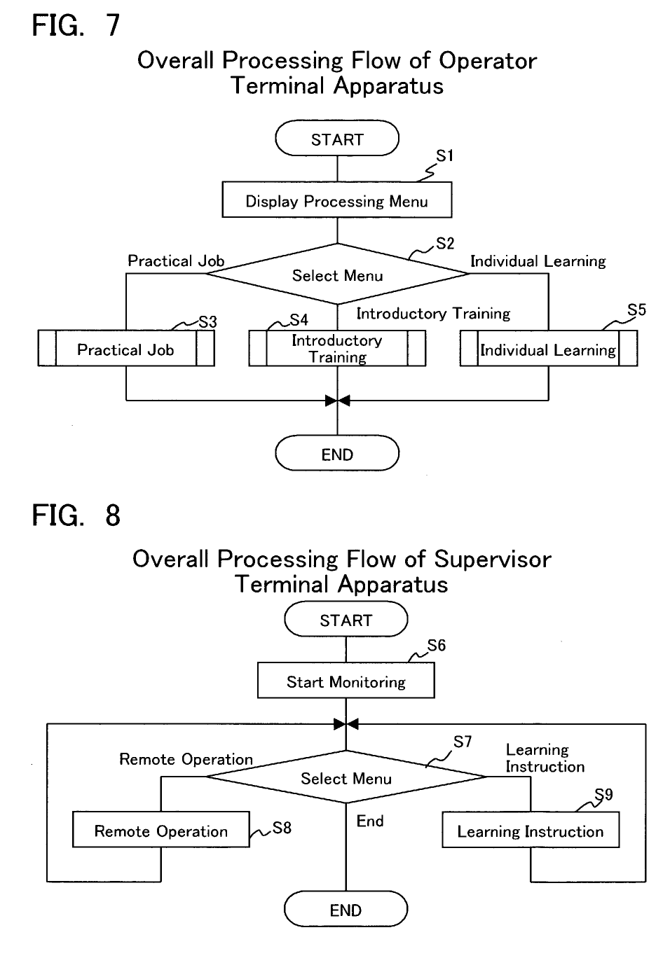

FIG. 3 shows an example of the curriculum data for use in the introductory training mode and the individual learning mode. FIG. 5 shows an example of the curriculum data for use in the practical job mode.

The curriculum data for use in the introductory training mode and the individual learning mode are separately prepared for curriculum items such as ‘customer search’ (or ‘customer retrieval’), ‘new customer registration’, etc. Each curriculum item corresponds to a complete set of function by which a series of operation is completed. Because the curriculum data are provided separately on curriculum item-by-item bases, any operator can learn the operation on a curriculum-by-curriculum basis. Such configuration of the curriculum data enables to identify an operation which is apt to mistake, and thus it becomes possible for the operator to learn repeatedly laying emphasis on such an operation.

In the practical job mode, an operator number (operator No.) is used correspondingly to a curriculum item. This is because operations apt to mistake are different operator by operator, and therefore each operator can learn laying emphasis on the operations apt to mistake.

In each script program, there is described a program corresponding to each curriculum item or each operator. ‘PROMPT’, ‘EXECUTE’, etc. are the instructions, and a character string following each instruction is an argument of the instruction. Some instructions have a plurality of arguments.

The instruction ‘PROMPT’ displays the contents of the argument onto a predetermined screen (window) of the display unit of computer 2a or 3a. For example, on execution of the ‘PROMPT’ instruction in the first line of the curriculum item ‘customer seach’ in FIG. 3, the argument following the instruction, namely, a character string of ‘Selecting an object customer from the customer list’ is displayed on the predetermined screen of the display unit.

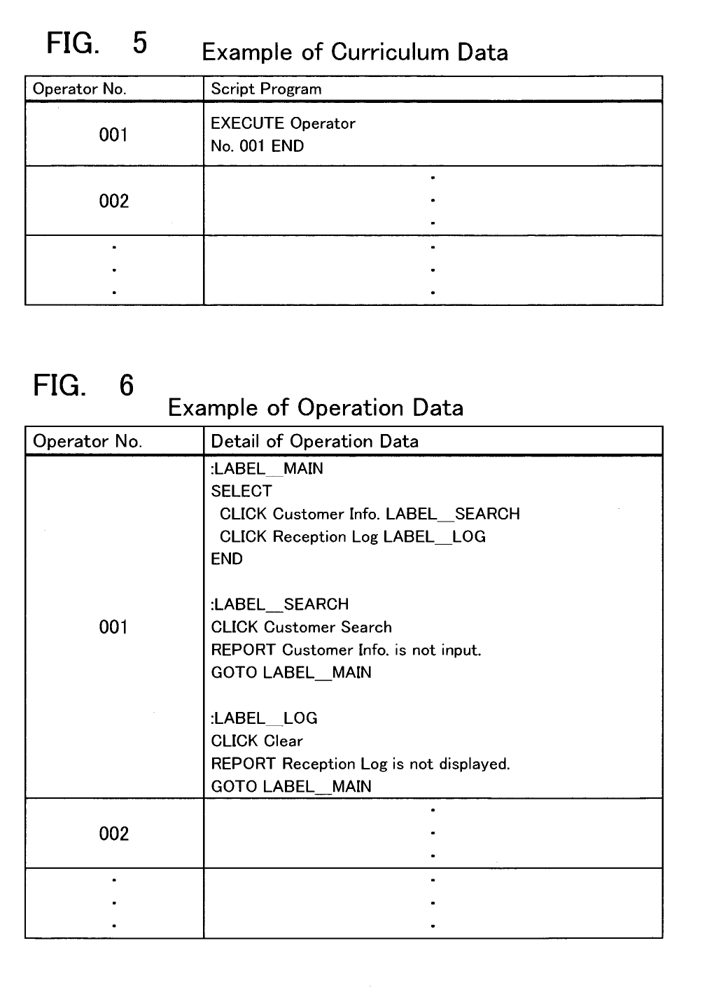

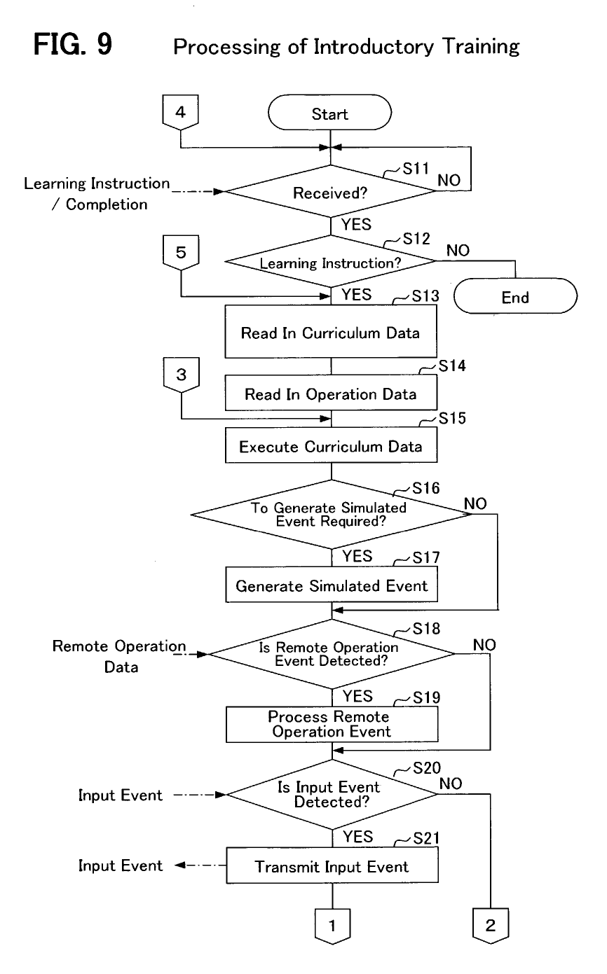

The instruction ‘EXECUTE’ executes an operation data in the argument. Examples of the operation data are shown in FIGS. 4 and 6 illustrated later. Additionally, the operation data include a processing of simulating to generate an incoming call signal and setting operator terminal apparatus 2 into a state of receiving the incoming call signal, thereby executing a simulated incoming call from a customer (which is not shown in FIGS. 4 and 6). Operation inspection unit 21 outputs a simulated event to event detection unit 23 by executing a generation operation of a simulated event including such a simulated incoming call signal.

In addition, in supervisor terminal apparatus 3, there are stored curriculum data, screen data for a main screen, etc. described later, and the like, although they are not shown in the figure.

FIG. 4 shows an example of the operation data for use in the first mode of the introductory training mode and the individual learning mode. FIG. 6 shows an example of the operation data for use in the practical job mode.

The operation data name shown in FIG. 4 or the operator No. shown in FIG. 6 corresponds to the argument of the EXECUTE instruction. For example, ‘EXECUTE customer search (1)’ executes an operation data having an operation data name ‘customer search (1)’. An operation data is constituted of one or more instruction elements which are sequentially executed by the EXECUTE instruction. The instruction elements include ‘CLICK’, ‘INPUT’, etc.

The instruction element ‘CLICK’ denotes an operation of clicking a button specified in the first argument in the case of one argument, while ‘CLICK’ denotes an operation of clicking an element in the second argument in a table specified in the first argument in the case of two arguments. On executing ‘CLICK’, operation inspection unit 21 performs a processing of reversing the display, or the like, of the button specified in the first argument, and indicates to the operator that the button of interest has been clicked. The instruction ‘INPUT’ denotes an operation of inputting contents specified in the second argument into an area specified in the first argument.

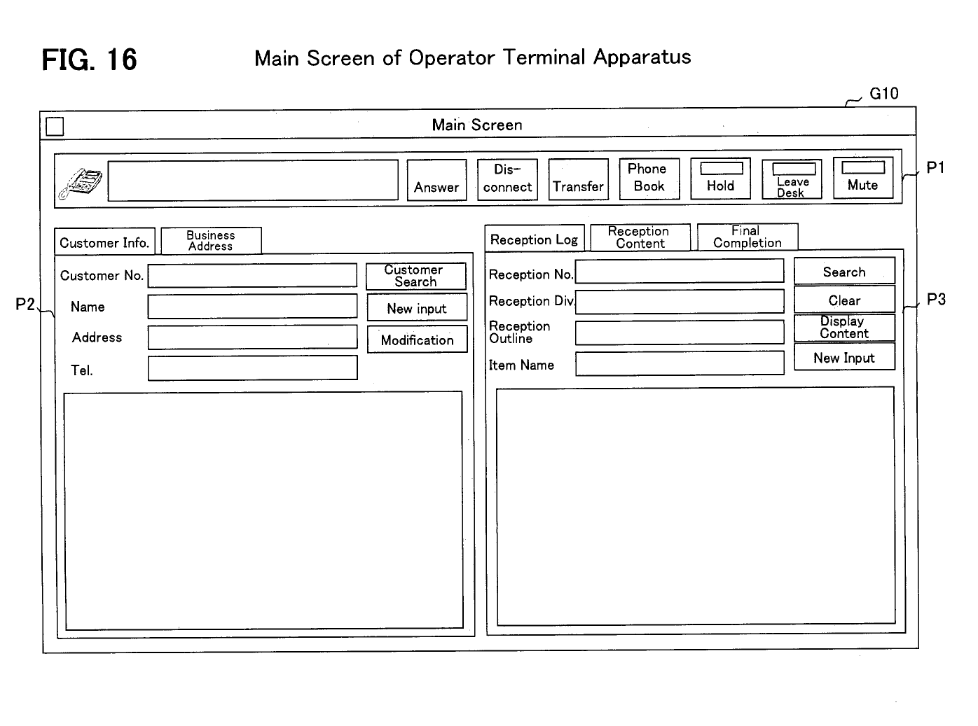

For example, on execution of the operation data ‘customer search (1)’, operation inspection unit 21 first reverses the display of a ‘customer search’ button displayed on the main screen (refer to FIG. 16 described later) of the display unit. Next, after the elapse of a predetermined time (for example, one second to several seconds), operation inspection unit 21 displays with reverse video the third element of the ‘customer list’ menu, and finally, displays a ‘confirmation’ button with reverse video. Thus, the operator is informed that these three click operations are performed consecutively.

Further, in the operation data shown in FIG. 6, there are illustrated operations an operator is apt to mistake in the practical job mode when the operator concerned is in a state shown in a label name which begins with ‘:’. For example, an operator having an operator No. 001 is apt to conduct an invalid operation at the two ‘CLICK’ operations described between ‘SELECT’ and ‘END’, when the operator concerned is in a state shown by ‘LABEL_MAIN’.

Operation inspection unit 21 supervises whether or not these two operations are performed based on the operation contents of the operator which is fed from event detection unit 23. When the ‘customer information’ is clicked, operation inspection unit 21 jumps to a line denoted by ‘LABEL_SEARCH’. Thereafter, when the ‘customer search’ is clicked, operation inspection unit 21 determines this operation is an invalid operation, and transmits a message denoted by the argument of ‘REPORT’ to supervisor terminal apparatus 3. Meanwhile, when a button other than the ‘customer search’ is clicked, operation inspection unit 21 determines this operation is invalid, and therefore returns to the original procedure in ‘GOTO LABEL_MAIN’ When a ‘reception log’ is clicked, operation inspection unit 21 also jumps to ‘LABEL_LOG’, and performs a processing shown by the operation data indicated therein.

Though not illustrated in the figure, some operations in the operation data include settings of the operation time condition for use in the third mode of the individual learning mode and the introductory training mode. Such operation time conditions are time conditions required in the operator's operation. Among these operation time conditions, there are classified into a time condition within time (in-time condition) which requires an operation within a predetermined time period, and a time condition after time (post-time condition) which requires an operation after the elapse of a predetermined time. For example, there is set an operation time condition in ‘CLICK’.

It may also be possible that curriculum data 221 and operation data 222 are stored in database server 5, so as to download from database server 5 to storage unit 22.

In the introductory training mode and the practical job mode, learning instruction unit 34 transmits learning instruction specified by the supervisor to operator terminal apparatus 2 through transmission/reception unit 35 and LAN 4. The transmitted learning instruction is supplied to operation inspection unit 21 through transmission/reception unit 27. In the individual learning mode, individual learning instruction unit 244 supplies the learning instruction selected by the operator to operation inspection unit 21. The learning instruction includes mode information denoting the mode, and curriculum items in each mode.

Operation inspection unit 21 executes corresponding curriculum data (script program) based on the mode and the curriculum item corresponding to the mode information which is included in the learning instruction supplied from supervisor terminal apparatus 3 or individual learning instruction unit 26. In the third mode of the introductory training mode and the individual learning mode, operation inspection unit 21 compares the operator's operation with the operation data to inspect whether the operator's operation is right or wrong, and scores the operation based on the inspection result (whether the operation is right or wrong). In the third mode of the introductory training mode, the inspection result and the score result are transmitted to learning condition supervision unit 33, as well as displayed on the display unit of operator terminal apparatus 2. In the individual learning mode, these results are displayed on the display unit of operator terminal apparatus 2.

The inspection result transmitted to learning condition supervision unit 33 includes contents of a valid operation, in addition to the operation contents operated by the operator and the information indicating an invalid operation, in the case the operator conducted the invalid operation.

Input unit 24 supplies the data being input to an input unit such as a keyboard and a mouse (not shown in FIG. 2) of computer 2a to event detection unit 23 as an input event. Input unit 24 is connected to a display unit (not shown in FIG. 2) of computer 2a. When display data is displayed on the display unit, input unit 24 supplies the display data (or identification information identifying the display data) to event detection unit 23 as an input event.

The input event includes identification information which represents a classified input. For example, when a particular button, icon, etc. is clicked using the mouse, identification information representing the clicked button, icon, etc. is included in the input event. When data is input via a keyboard, an input field of the data and the input data are included in the input event. Telephone call reception unit 25 is connected to interface unit 2c. When there is an incoming call from a customer, an input event representing a call arrival is supplied to event detection unit 23.

Event detection unit 23 detects the input event from input unit 24 and telephone call reception unit 25, a simulated event from operation inspection unit 21, and a remote operation event supplied from remote terminal operation unit 32. Event detection unit 23 then supplies such detected events to remote terminal supervision unit 31. Also, event detection unit 23 supplies the input event received from input unit 24 to operation inspection unit 21.

Remote terminal supervision unit 31 supervises a condition of operator terminal apparatus 2 based on the event received from event detection unit 23. This supervision includes a processing of displaying onto the display unit (not shown in FIG. 2) of supervisor terminal apparatus 2 the operation contents operated by the operator of operator terminal apparatus 2 and the screen of the display unit of operator terminal apparatus 2.

Remote terminal operation unit 32 transmits a remote operation input by the supervisor to operator terminal apparatus 2 through LAN 4. Learning condition supervision unit 33 displays the comparison result and the score result received from operation inspection unit 21 to the display unit of supervisor terminal apparatus 3.

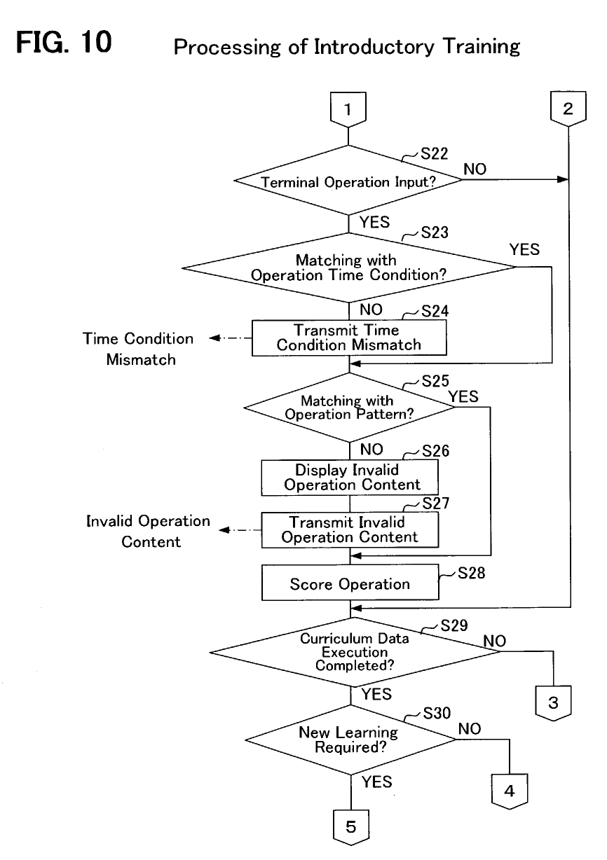

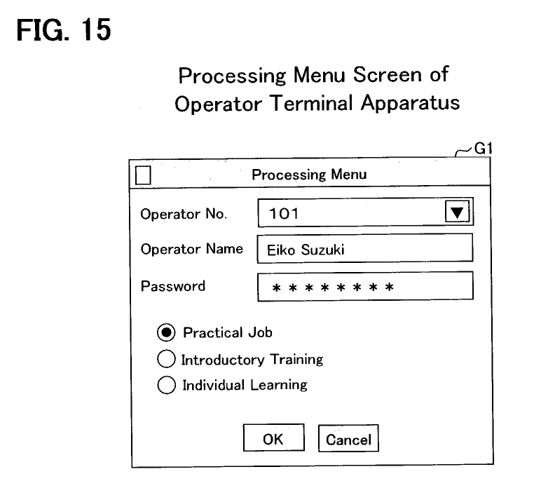

FIG. 7 is a flowchart illustrating an overall processing of operator terminal apparatus 2. When operator terminal apparatus 2 is powered on and activated, operator terminal apparatus 2 displays onto its display unit a processing menu screen (window) Gi shown in FIG. 15 (S1).

The operator then inputs the operator No., the operator name, and the password in this processing menu screen G1, and also selects any one of the practical job mode, the introductory training mode, and the individual learning mode, and then clicks an OK button (S2). The operator No. may be selected from a pull-down menu. When a cancel button is clicked, operator terminal apparatus 2 closes this processing menu screen, and performs ordinary processing of the OS (Operating System), etc.

When the OK button is clicked, operator terminal apparatus 2 transmits the input operator No., operator name, and password to database server 5. Database server 5 then compares the transmitted information with operator information stored in advance, and checks whether any coincident operator information exists.

When the transmitted operator information coincides with any operator information stored in database server 5, database server 5 authenticates the operator, and the fact of the authentication completion is transmitted to operator terminal apparatus 2. After this authentication, operator terminal apparatus 2 displays a main screen G10 shown in FIG. 16 on the display unit. This main screen G10 is identical to a main screen for use in the practical job in which the operator receives a customer through the telephone.

Meanwhile, when the transmitted operator information does not coincide with any operator information stored in database server 5, the authentication is not performed, and the fact of no authentication performed is transmitted to operator terminal apparatus 2. Operator terminal apparatus 2 then displays the processing menu screen, and urges the operator to reenter an operator No., etc.

In the upper part of the main screen G10, a telephone operation section P1 is provided, in which an answer button for answering an incoming telephone call, a disconnect button for disconnecting the telephone call, etc. are arranged. These buttons can be selected by clicking the mouse. On the left side of the main screen G10, a customer information display section P2 is arranged, while on the right side of the main screen G10, a reception log section P3 is arranged. In customer information display section P2, there are arranged a customer search button, a new input button, a modification button, etc., which are clicked by the mouse. The operation of these buttons corresponds to the operation ‘CLICK’ in the operation data described earlier.

When the operator is authenticated, operator terminal apparatus 2 performs processing corresponding to one of the mode selected out of the practical job mode, the introductory training mode and the individual learning mode (S3-S5).

On selection of either the practical job mode or the introductory training mode, operator terminal apparatus 2 is connected to both supervisor terminal apparatus 3 and database server 5 through LAN 4. This enables supervisor terminal apparatus 3 to monitor operator terminal apparatus 2. Meanwhile, on selection of the individual learning mode, operator terminal apparatus 2 becomes in a stand-alone state, and is disconnected from LAN 4. Accordingly, during the individual learning mode, operator terminal apparatus 2 is not monitored by supervisor terminal apparatus 3.

Here, on selection of either the introductory training mode or the individual learning mode, it may also be possible to select the whole modes from the first mode through the third mode automatically, and thus the processing for the whole modes may be executed. Alternatively, it may be possible to display a selection screen (not shown) for selecting one of the modes among the first mode to the third mode, and the supervisor or the operator selects one mode or more using the selection screen for execution.

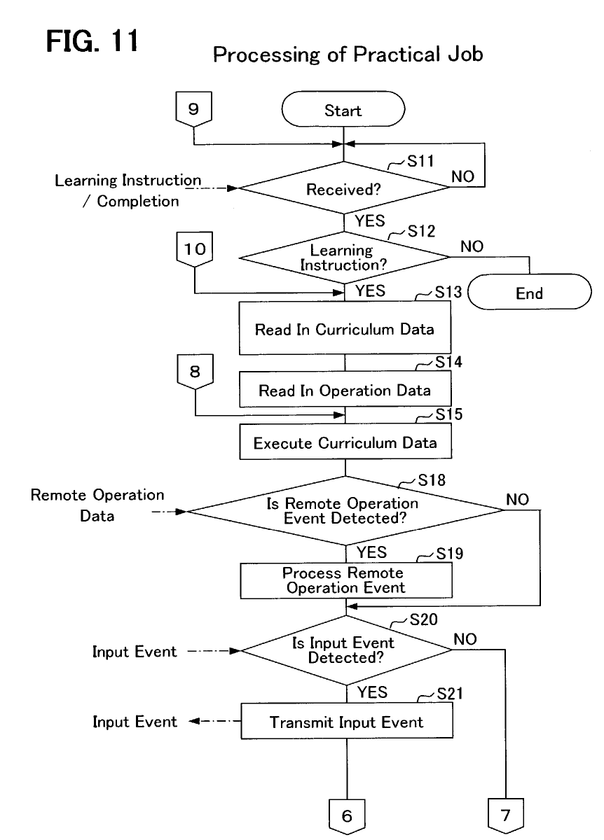

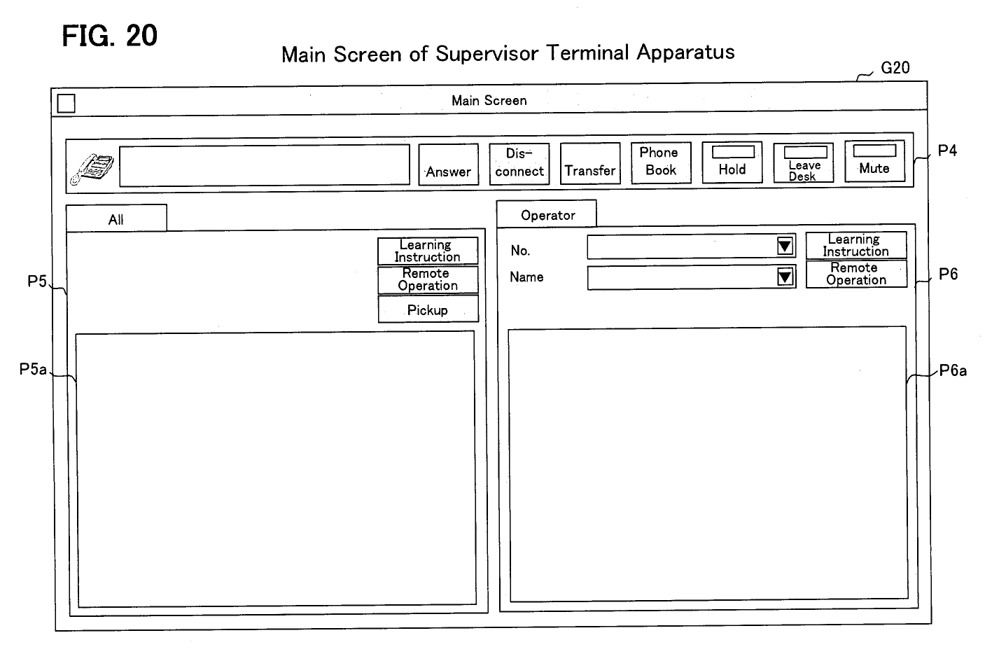

FIG. 8 is a flowchart illustrating an overall processing of the supervisor terminal apparatus 3. When supervisor terminal apparatus 3 is powered on and activated, supervisor terminal apparatus 3 displays onto its display unit the main screen (window) G20 shown in FIG. 20, and starts to monitor operator terminal apparatus 2 situated in either the practical job mode or the introductory training mode via LAN 4 (S6).

The main screen G20 has an entire staff display section P5 and an operator display section P6, in addition to telephone operation section P4 having an identical configuration to telephone operation section P1 in the main screen of operator terminal apparatus 2.

The entire staff display section P5 has a learning instruction button, a remote operation button and a pickup button, which are prepared as an operation menu for a click operation, in addition to a display section P5a which displays conditions of the whole operator terminal apparatuses 2 currently under monitoring.

Operator display section P6 has a learning instruction button and a remote operation button, which are prepared as an operation menu for a click operation, in addition to a display section P6a which displays the condition of a particular operator terminal apparatus out of the entire operator terminal apparatuses 2. Further, operator display section P6 has columns for displaying an operator No. and an operator's name. A pull-down menu is provided in these two columns, by which the supervisor can select an operator. The current condition of operator terminal apparatus 2 in use by the selected operator may be displayed on display section P6a.

Display sections P5a, P6a are controlled by remote terminal supervision unit 31 and learning condition supervision unit 33 (refer to FIG. 2). The events received by remote terminal supervision unit 31, the score results received by learning condition supervision unit 33, etc. are displayed on these display sections P5a, P6a.

By clicking (selecting the menu) the learning instruction button provided in the entire staff display section P5 (S7), the supervisor can transmit learning instructions to the whole operator terminal apparatuses 2 which are situated in either the introductory training mode or the practical job mode (S9). Also, by clicking (selecting the menu) the remote operation button provided in the entire staff display section P5 (S7), the supervisor can perform remote operation against the entire operator terminal apparatuses 2 which are situated in the introductory training mode.

The pick-up button is used for picking up one of the operator terminal apparatuses (operators) displayed on display section P5a of the entire staff display section P5. The condition of operator terminal apparatus 2 having been picked up is displayed on operator display section P6. In order to select one operator terminal apparatus out of a plurality of operator terminal apparatuses displayed on the entire staff display section P5, it may be possible either to input an operator number in the operator No. column of operator display section P6, or to select from the pull-down menu, as described earlier.

Meanwhile, the supervisor can supply a learning instruction to only one operator by clicking (selecting the menu) the learning instruction button provided in operator display section P6. Also, the supervisor can perform a remote operation to only one operator by clicking the remote operation button on operator display section P6.

Now, hereafter details of learning/training support processing in each mode are described in order of the introductory training mode, the practical job mode, and the individual learning mode.

Processing in the Introductory Training Mode

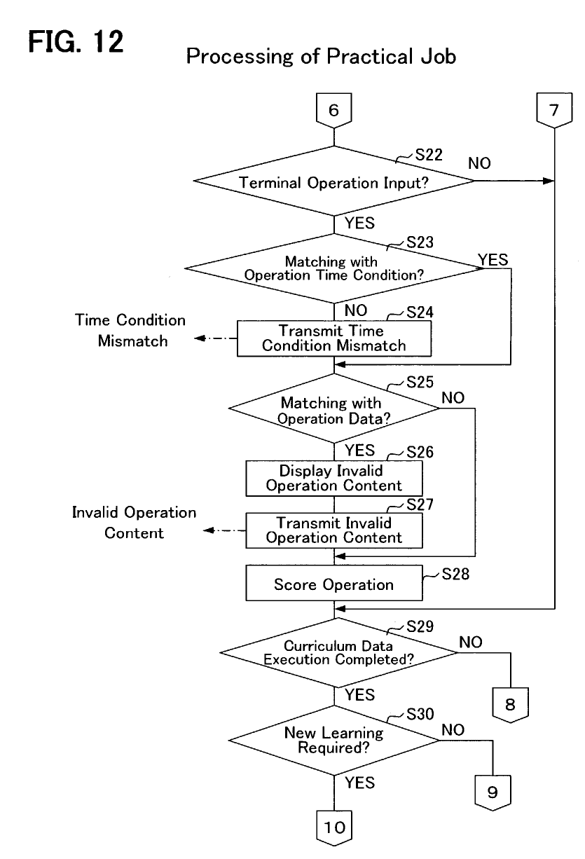

FIGS. 9 and 10 show a flowchart illustrating the flow of learning/training support processing of operator terminal apparatus 2 in the introductory training mode.

When the operator selects the introductory training using the aforementioned processing menu screen G1, operator terminal apparatus 2 starts the processing of the introductory training mode. After the start, operator terminal apparatus 2 waits for a message from supervisor terminal apparatus 3 (S11).

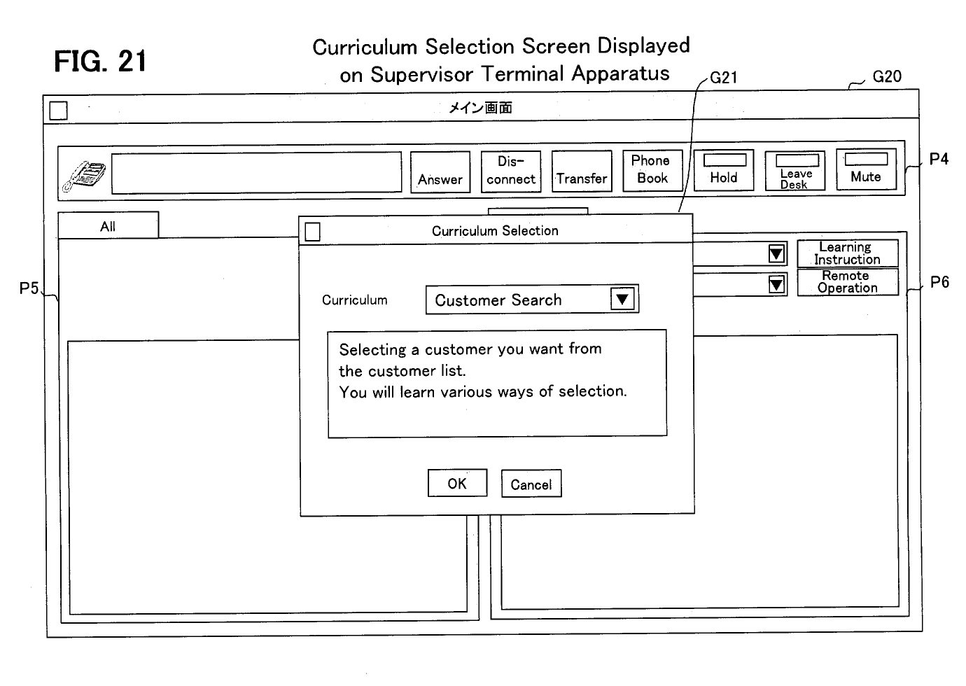

When the supervisor clicks either the learning instruction button in the entire staff display section P5 or the learning instruction button in the operator display section P6, supervisor terminal apparatus 3 displays a curriculum selection screen G21 shown in FIG. 21.

Curriculum selection screen G21 includes a curriculum selection column, and a curriculum outline display column disposed below the curriculum selection column. The curriculum selection column has a pull-down menu. This pull-down menu has a list of curriculum items in the curriculum data stored in supervisor terminal apparatus 3. The supervisor can select one curriculum item from the pull-down menu. In FIG. 21, ‘customer search’ has been selected. When the curriculum item is selected, the outline of the selected curriculum is displayed on the curriculum outline display column. In order to display this outline, for example, the contents of the argument in the PROMPT instruction of the script program are used.

After the curriculum is selected, when the supervisor clicks the OK button, learning instruction unit 34 transmits to operation inspection unit 21 a learning instruction message including the selected curriculum item name. When the curriculum is selected by use of the learning instruction button in the entire staff display section P5, the learning instruction messages are transmitted to the entire operator terminal apparatuses 2 which are situated in the introductory training mode. On the other hand, when the curriculum is selected by use of the learning instruction button in the operator display section P6, the learning instruction message is transmitted only to operator terminal apparatus 2 specified in the above-mentioned operator display section P6.

Though an illustration is omitted in the figure, it is possible for the supervisor to select completion when the introductory training is to complete. On selection of completion, learning instruction unit 34 transmits a completion message to operation inspection unit 21.

On receipt of the message from supervisor terminal apparatus 3 (‘Yes’ in S11), operation inspection unit 21 checks whether the message is a learning instruction message or a completion message (S12). If the message is the completion message (‘No’ in S12), operation inspection unit 21 terminates the processing. On the other hand, if the message is the learning instruction message (‘Yes’ in S12), operation inspection unit 21 reads from storage unit 22 curriculum data 221 corresponding to the curriculum item name included in the learning instruction message, and operation data 222 corresponding to the aforementioned curriculum data 221 (S13, S14).

Subsequently, operation inspection unit 21 executes the script program of the read curriculum data (S15). As mentioned above, the entire script programs from the first mode to the third mode may be executed in some cases, while in other cases only the script program of the selected mode may be executed.

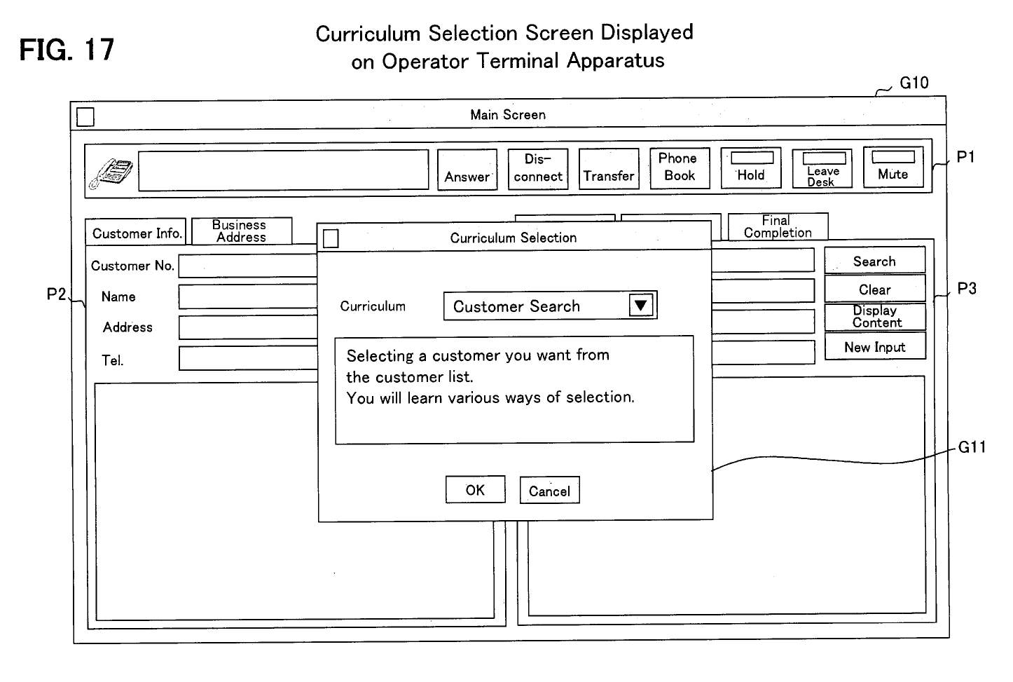

For example, when ‘customer search’ is selected as a curriculum item, in the first mode, operation inspection unit 21 displays a curriculum selection screen G11 shown in FIG. 17 (which is the same screen as curriculum selection screen G21 shown in FIG. 21), and the selected curriculum item and the argument of the ‘PROMPT’ instruction (refer to FIG. 3) are displayed on this screen G11.

Operation inspection unit 21 executes the ‘PROMPT’ instructions in the first and the second lines of the ‘customer search’ shown in FIG. 3, and thereafter executes the ‘EXECUTE’ instruction in the third line. With these instructions, operation inspection unit 21 deletes curriculum selection screen G11, and then performs three ‘CLICK’ operations in ‘customer search (1)’ shown in FIG. 4, and thus the processing of the first mode is performed. In other words, operation inspection unit 21 displays with reverse video the button or menu elements specified in the arguments of the three ‘CLICK’ operations one after another, so that the buttons to be operated and the operation sequence thereof are visually represented to the operator.

When the second mode is selected, the second mode processing is executed in respect of the selected curriculum item after the first mode processing is completed. Further, when the third mode is additionally selected, the third mode processing is executed after the first mode processing and the second mode processing are completed.

In the third mode processing, when the simulated event generation processing is included (‘Yes’ inS16), operation inspection unit 21 generates a simulated event and supplies the event to event detection unit 23 (S17).

In case of receiving a remote operation event from remote terminal operation unit 32 (‘Yes’ in S18), event detection unit 23 executes processing corresponding to the remote operation event concerned. The remote operation event includes a remote operation start message, a remote operation message transmitted after the start of the remote operation, and a remote operation completion message.

The remote operation start message is transmitted to event detection unit 23 when either the remote operation button provided in the entire staff display section P5 or the remote operation button in operator display section P6 in the main screen (refer to FIG. 20) of supervisor terminal apparatus 3 is clicked. When the remote operation button in the entire staff display section P5 is clicked, the remote operation event is transmitted to the entire operator terminal apparatuses situated in the introductory training mode. Meanwhile, when the remote operation button in operator display section P6 is clicked, the remote operation event is transmitted only to the operator terminal apparatus which is selected in operator display section P6.

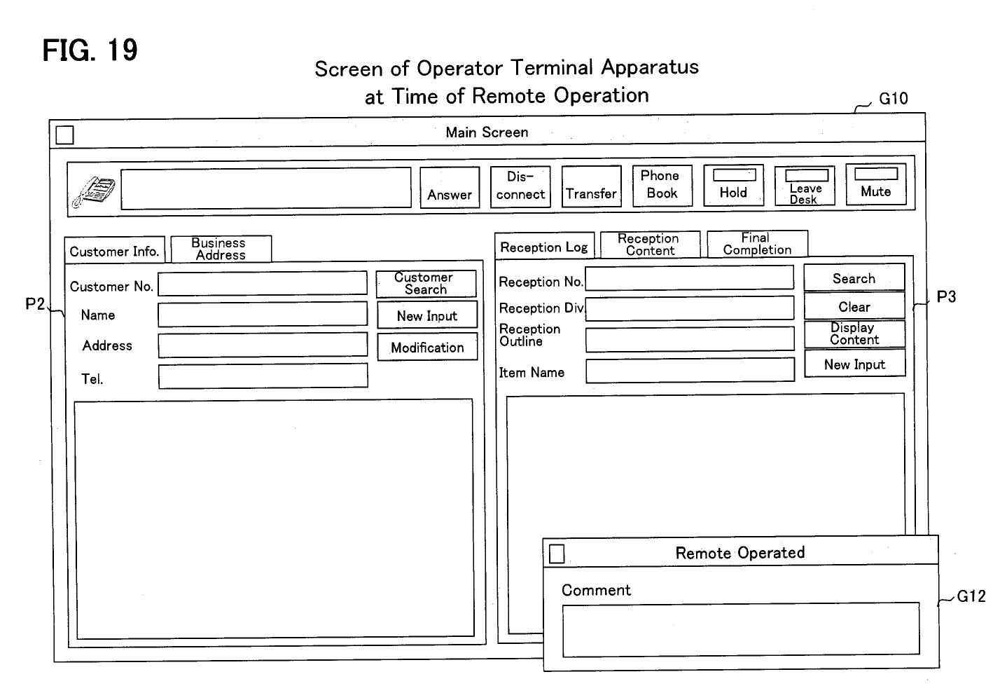

On receipt of the remote operation start message, event detection unit 23 displays a remote operation notification screen G12 shown in FIG. 19 onto the display unit of operator terminal apparatus 2 in a different window. This enables the operator to know the remote operation has started.

Meanwhile, when the remote operation button is clicked by the supervisor, remote terminal operation unit 32 in supervisor terminal apparatus 3 displays a main screen G22 having the same configuration as the main screen of operator terminal apparatus 2 (refer to FIG. 16) onto the display unit in a different window. The supervisor clicks a variety of buttons provided in this main screen G22, performs operations such as inputting necessary data in the input columns, so that the supervisor can instruct the operator. With these operations by the supervisor, remote terminal operation unit 32 transmits the operation contents to event detection unit 23 as remote operation messages. On receipt of each remote operation message, event detection unit 23 executes in operator terminal apparatus 2 the same operation as the operation contents included in the remote operation message.

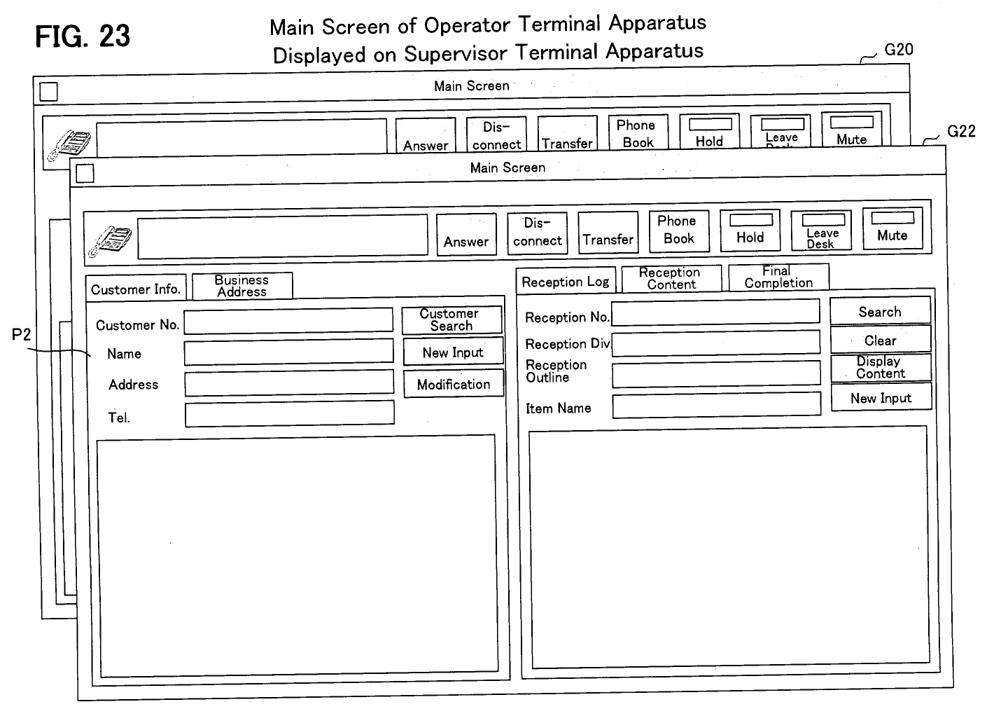

For example, in the main screen G22 of supervisor terminal apparatus 3 (refer to FIG. 23), when the customer search button in customer information display section P2 is clicked by the supervisor, identification information of this button and operation information representing the click operation are transmitted to event detection unit 23 as a remote operation message. Based on this remote operation message, event detection unit 23 notifies the operator of this clicked button in the remote operation by displaying the customer search button with reverse video, or the like, in customer information display section P2 in the main screen G10 (refer to FIG. 19) of operator terminal apparatus 2. At the same time, event detection unit 23 executes a necessary processing when the button of interest is clicked.

In short, in the remote operation, the operations performed by the supervisor at supervisor terminal apparatus 3 is reflected to operator terminal apparatus 2, and both terminal apparatuses execute processing synchronously.

Additionally, operation inspection unit 21 may suspend processing while a remote operation is being carried out. Or, operation inspection unit 21 may receive the remote operation message from event detection unit 23 and supervise a curriculum progress state carried out by the remote operation based on the received remote operation message. When the progress state is supervised, after the remote operation is completed, operation inspection unit 21 may resume the curriculum from the completion condition.

Referring back to the flowchart shown in FIG. 9, on detection of an input event from input unit 24 (‘Yes’ in S20), event detection unit 23 transmits the input event to remote terminal supervision unit 31 (S21), and supplies this input event to operation inspection unit 21.

In the process proceeding to FIG. 10, operation inspection unit 21 determines whether or not the input event supplied from event detection unit 23 is a terminal operation input by the operator (S22). If the input event is the terminal operation input by the operator (‘Yes’ in S22), operation inspectionunit21 checks whether the input event matches with an operation time condition of operation data 222 (S23). For example, in ‘customer search (1)’, the operation time of the first operation contents (input event) by the operator supplied from event detection unit 23 is compared with the operation time condition which is set in ‘CLICK customer search’ specified in the first line of the operation data, and it is checked whether or not this comparison results in a match.

If the input event matches with the operation time condition, operation inspection unit 21 reserves this match state as score information, and the process proceeds to the step S25. On the other hand, if the input event does not match, for example, in the case that an in-time condition is preset and the operator operates after the elapse of the preset time, or in the case that a post-time condition is preset and the operator operates before the preset time elapses, operation inspection unit 21 reserves this state of mismatch as score information into operation inspection unit 21, and transmits a message indicative of the state of time condition mismatch to learning condition supervision unit 33 (S24). Here, it may be possible for operation inspection unit 21 to transmit a message to learning condition supervision unit 33 also in case of the match, which indicates a match state of the time condition.

Subsequently, operation inspection unit 21 compares the input event with operation data 222, and determines whether the operator's operation matches with operation data 222 (S13). For example, in ‘customer search (1)’, a first operation result by the operator (input event) supplied from event detection unit 23 is compared with ‘CLICK customer search’ specified in the first line of the operation data, and it is determined whether or not this comparison result matches.

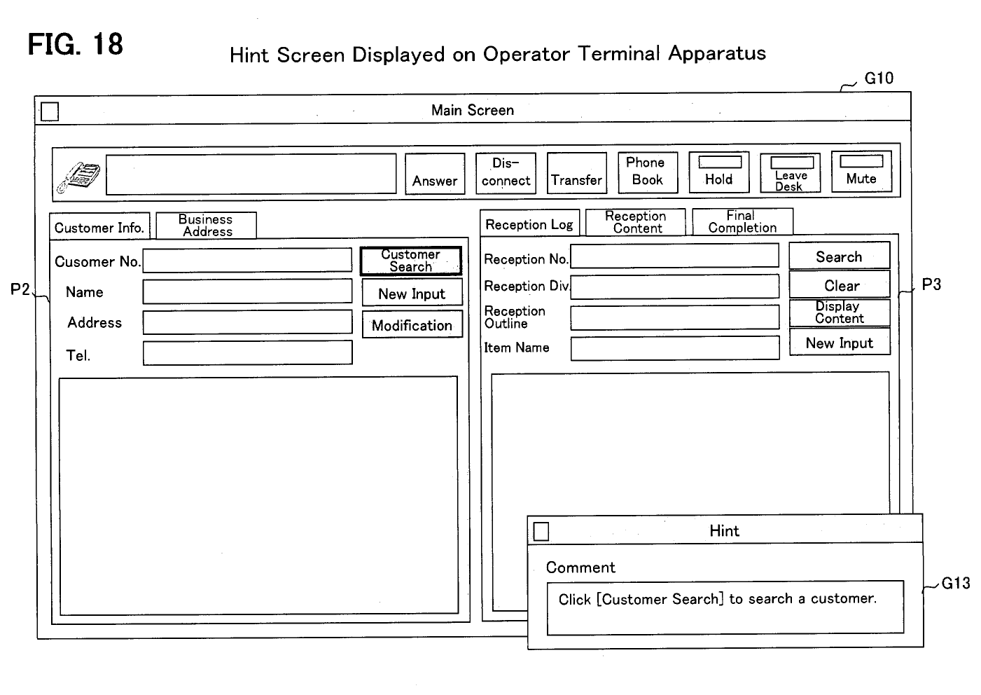

If the comparison result is a match (‘Yes’ in S25) operation inspection unit 21 reserves this match state as score information, and the process proceeds to the step S28. On the other hand, if the comparison result does not match (‘No’ in S25), operation inspection unit 21 displays a hint screen G13 onto the display unit, as shown in FIG. 18, and at the same time, for example, displays with reverse video a valid button which is to be operated onto the display unit. In FIG. 18, the customer search button in customer information display section P2 is displayed with reverse video as a button to be operated (clicked) in a valid operation.

Also, if the comparison result does not match, operation inspection unit 21 reserves the invalid operation content as score information into operation inspection unit 21, and transmits the invalid operation content to learning condition supervision unit 33 (S27). Here, also when the comparison results in a match, it maybe possible to transmit a match state indication to learning condition supervision unit 33.

Subsequently, operation inspection unit 21 scores the operator's operation content based on the score information reserved therein (S28). This scoring may be performed either by calculating the score in a form of a numerical value based on a predetermined score table, or by obtaining a rank based on a skill degree rank table. The score table is constituted of, for example, each operation and an allocated score to the operation of interest. The scoring is performed in such a way that an allocated score is acquired when an operation is valid and matches with the operation time condition. The score table and the skill degree rank table are stored in storage unit 22 in advance, though not shown in the figure.

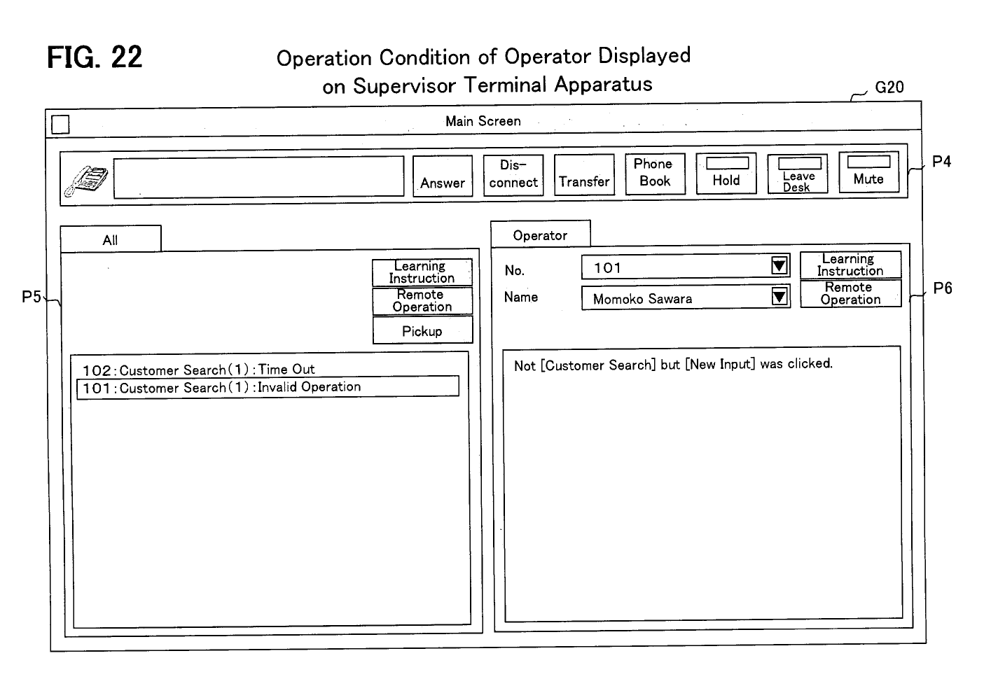

Based on the input event, the time condition mismatch message and the invalid operation contents which are transmitted from operator terminal apparatus 2, remote terminal supervision unit 31 and learning condition supervision unit 33 display the conditions of operators on respective operator terminal apparatuses 2 onto operator display section P6 and the entire staff display section P5 of the main screen G20, as shown in FIG. 22.

In the entire staff display section P5, because the conditions of the entire operators situated in the introductory training mode are displayed, only outlines of the conditions are displayed therein. For example, as shown in FIG. 22, there are displayed operator Nos. such as ‘102’ and ‘101’, each argument name of the ‘EXECUTE’ instruction such as ‘customer search (1)’ which is being executed by each operator terminal apparatus of the operator, and operator's operation results such as ‘timeout’ and ‘invalid operation’. The display of ‘timeout’ represents that the operator did not operate an operation having a preset in-time condition within the preset time. The display of ‘invalid operation’ represents the operation was invalid (for example, an invalid button was clicked).

In such a way, on the entire staff display section P5, there are displayed conditions of the entire operators, and further whether the operation results are right or wrong, and the evaluation results obtained by inspecting the operation time conditions are displayed by operation inspection unit 21. Thus, the supervisor can easily grasp each operator's learning state of progress. Moreover, the supervisor can easily identify operations each operator is apt to mistake or spend much time, and the like. Accordingly, it becomes possible to determine easily future training items to be emphasized for each operator, which may bring about efficiency in learning and training.

Also, after the curriculum is completed, learning condition supervision unit 33 displays the score results transmitted from operation inspection unit 21 of each operator terminal apparatus onto the entire staff display section P5. Also with this means, the supervisor can grasp each operator's learning state of progress.

When it is desired to display a detailed operation condition with regard to one particular operator shown in the entire staff display section P5, operator display section P6 located on the right side of the main screen G20 is used, as described earlier. In FIG. 22, there is displayed the detailed condition of the operator No. 101, indicating a detailed content of the ‘invalid operation’ as “‘New input’ was clicked instead of ‘Customer search’”.

Referring back to FIG. 10, operation inspection unit 21 determines whether execution of the entire instructions is completed (in other words, the process reaches ‘END’ of the script program) each time an instruction of the script program is executed sequentially (S29). If the entire script program has not been executed, the processing is repeated for the step S14.

On the other hand, if the entire script program has been completed (‘Yes’ in S29), operation inspection unit 21 transmits a curriculum data completion notification to learning condition supervision unit 33. At the same time, operation inspection unit 21 determines whether or not new learning is necessary based on the score result (S21). Whether or not the new learning is necessary is determined by comparing the operator's score with a score threshold, for example. When the operator's score is not lower than the threshold, it is determined that new learning is not necessary, while when the score is lower than the threshold, it is determined new learning is necessary.

In the case new learning is determined necessary, a learning curriculum necessary for the new learning is also prepared in advance, which is set in storage unit 22. For example, corresponding to the curriculum item having been learnt by the operator and the score of the operator at that time, each new learning curriculum is prepared in advance. More specifically, as one example, in the curriculum item ‘customer search’, when an operator's score is lower than 50 points, a curriculum for learning more basic operation contents is correspondingly prepared. When the score is not lower than 50 points and lower than 70 points, an identical curriculum item ‘customer search’ is correspondingly prepared.

If new learning is determined necessary (‘Yes’ in S30), operation inspection unit 21 repeats the processing from the step S13 with regard to a curriculum item corresponding to the operator's score.

Meanwhile, if new learning is determined unnecessary (‘No’ in S30), the processing is completed. As a result, operator terminal apparatus 2 returns to the condition of the step S11. Here, there maybe a case that the supervisor transmits new learning instruction to operator terminal apparatus 2, depending on the score result supplied from operation inspection unit 21 to learning condition supervision unit 33. Initiated by this new learning instruction, operator terminal apparatus 2 resumes to start the processing from the step S12.

As may be understood from the aforementioned description, in the introductory training, because the evaluation result obtained by operation inspection unit 21 is transmitted to supervisor terminal apparatus 3 and displayed, the supervisor can easily grasp each operator's learning state of progress. Further, it becomes possible to determine future training items to be emphasized for each operator. This enables efficient learning and training. Moreover, because the score result is displayed for each operator after the curriculum completion, the supervisor can grasp each operator's learning state of progress easily using this score result.

Processing in the Practical Job Mode

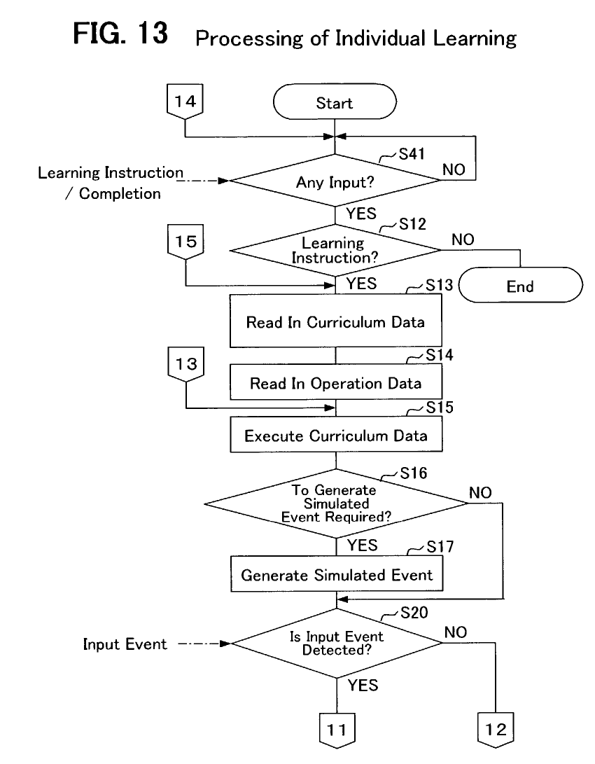

FIGS. 11 and 12 are flowcharts illustrating a flow of learning/training support processing of operator terminal apparatus 2 in the practical job mode. As for the processing identical to the processing shown in FIGS. 9 and 10, identical numerals and symbols are assigned, and the detailed explanation is omitted.

In the practical job mode also, operation inspection unit 21 executes the processing shown in the steps S11 through S15, similarly to the case of the introductory training mode. Accordingly, when a learning instruction message is received from learning instruction unit 34, operation inspection unit 21 executes the curriculum item (operator No.) included in the learning instruction message.

Here, the curriculum data and the operation data which operation inspection unit 21 reads in from storage unit 22 are the data shown in FIGS. 5 and 6 for use in the practical job mode. Also, in the practical job mode, there is no such mode type as the first mode to the third mode in the introductory training mode. Along with the actual customer reception processing (practical job processing) through the telephone, the curriculum data is executed.

In the practical job mode, the processing of generating a simulated event is not included in the curriculum data, because learning/training support is performed in the practical job. Accordingly, in the processing of the practical job mode, the processing of the steps S16 and S17 shown in FIG. 9 are not included. Namely, event detection unit 23 detects either a remote operation event or an input event during execution of the curriculum data (S18, S20), and on detection of such an event, the processing corresponding to such an event is executed (S19, S21).

Referring now to FIG. 12, when the input event is a terminal operation input by the operator (‘Yes’ in S22), operation inspection unit 21 determines whether the terminal operation input matches with an operation time condition (S23). If the terminal operation input does not match with the operation time condition, the time condition mismatch message is transmitted to learning condition supervision unit 33 (S24).

Also, operation inspection unit 21 determines whether or not the input event matches with the operation data (operation pattern) (S25). Here, because the operation data in the practical job mode describes an operation which the operator is apt to mistake (refer to FIG. 6), when the input event matches with the operation data, it is determined that the operator's operation is invalid. Accordingly, in case the input event matches with the operation pattern (‘Yes’ in S25), operation inspection unit 21 displays the invalid operation content to the display unit of the operator terminal apparatus 2 (S27), and at the same time, transmits the invalid operation content to learning condition supervision unit 33 (S28).

Thereafter, operation inspection unit 21 scores the operator's operation (S28), and then executes the processing shown in the steps S29 and S30. The scoring result is transmitted to learning condition supervision unit 33.

It may be possible to omit the processing related to the operation time condition shown in the steps S23, S24. Also, it may be possible to execute the processing in the steps S23, S24 with regard to the operation which matches with the operation pattern (that is, an invalid operation).

In such a way, while the operator is performing a practical job of receiving customers, it is possible to support learning and training to the operator, which enables operational support to operators particularly at an early stage after the introductory training.

Processing in the Individual Learning Mode

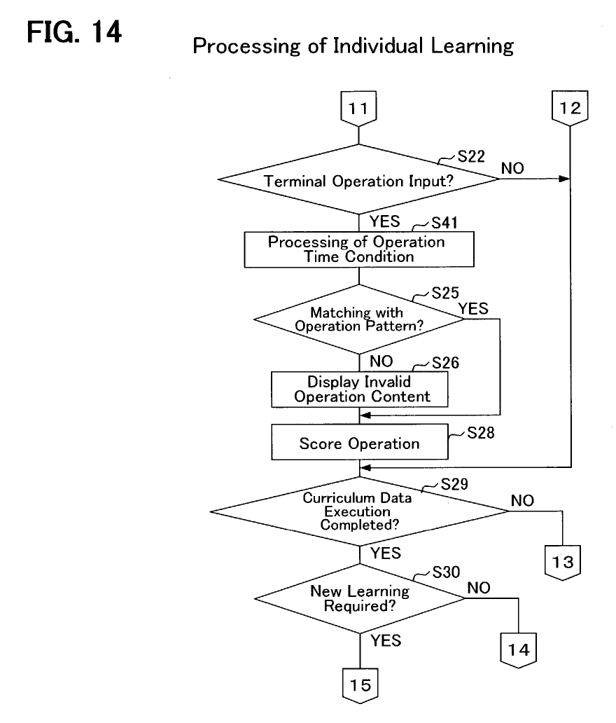

FIGS. 13 and 14 are flowcharts illustrating a flow of learning/training support processing in operator terminal apparatus 2 in the individual learning mode. Identical numerals and symbols are assigned to the processing identical to that shown in FIGS. 9, 10, and detailed description is omitted for such processing.

In the individual learning mode, operator terminal apparatus 2 conducts learning/training support processing in a stand-alone state. Therefore, learning instruction or completion instruction is input from the operator who is operating operator terminal apparatus 2 through individual learning instruction unit 26, instead of from supervisor terminal apparatus 3 (S41). When a learning instruction is input (‘Yes’ in S12), the steps S13 to S15 are executed. In the step S15, either the entire sets of processing from the first mode through the third mode or only the processing of the selected mode may be executed.

During the processing of the third mode, operation inspection unit 21 outputs a simulated event to event detection unit 23 through the simulated event generation processing (S16, S17). Meanwhile, in the third mode, there is no remote operation carried out from supervisor terminal apparatus 3. Accordingly, the remote operation event detection processing (the steps S18 and S19 shown in FIG. 9) is omitted.

When the input event from the operator is supplied to operation inspection unit 21 through event detection unit 23 (‘Yes’ in S20), operation inspection unit 21 determines whether the input event is a terminal operation input. If the input event is the terminal operation input (‘Yes’ in S22), operation inspection unit 21 checks whether the operation matches with the operation time condition, and the determined result is reserved as score information.

Subsequently, operation inspection unit 21 executes the steps S25, S26. However, in this case of the individual learning mode, an invalid operation content is not transmitted to supervisor terminal apparatus 3. Thereafter, operation inspection unit 21 executes the processing of the steps S28, S29 and S30.

In such a manner, in the individual learning mode, operation inspection unit 21 inspects the operation and the inspection result is displayed onto the display unit of operator terminal apparatus 2. With this means, the operator can grasp the learning state of progress. Further, displaying an invalid operation enables the operator to recognize future learning points easily, which results in improving learning efficiency.

To summarize, according to the present invention, a supervisor can recognize the validity of trainee's operations without need of making his own decision. Therefore, the supervisor can grasp the trainees learning state of progress and the points each trainee is apt to mistake in operation. As a result, training efficiency of the supervisor can be improved, as well as the training can be performed efficiently.

The foregoing description of the embodiments is not intended to limit the invention to the particular details of the examples illustrated. Any suitable modification and equivalents maybe resorted to the scope of the invention. All features and advantages of the invention which fall within the scope of the invention are covered by the appended claims.

What is claimed is:

1. A terminal operation training apparatus for supporting operation training of an operator terminal apparatus for use in receiving customers, comprising:
a storage unit, which stores operation data representing a valid or invalid operation procedure of the operator terminal apparatus;
a display unit, which displays an operation screen of the operator terminal apparatus;
an input unit, which inputs operations of a learner corresponding to said operation screen;
an operation inspection unit, which compares the operations input through said input unit with the operation data and inspects validity of the operations; and
a transmission unit, which transmits an inspection result obtained by said operation inspection unit to a supervisor terminal apparatus which is connected to the terminal operation training apparatus through a communication line.

2. The terminal operation training apparatus according to claim 1, wherein, when said operation data represents a valid operation procedure, said transmission unit transmits to the supervisor terminal apparatus one or more operations which does not match with said operation data as the inspection result, and when said operation data represents an invalid operation procedure, said transmission unit transmits to the supervisor terminal apparatus one or more operations which matches with said operation data as the inspection result.

3. The terminal operation training apparatus according to claim 1, wherein said transmission unit transmits to the supervisor terminal apparatus both the operations input to said input unit and operations included in the operation data compared with said input operations, together with the inspection result.

4. The terminal operation training apparatus according to claim 2, wherein said transmission unit transmits to the supervisor terminal apparatus both the operations input to said input unit and operations included in the operation data compared with said input operations, together with the inspection result.

5. The terminal operation training apparatus according to claim 1,
wherein the operation data further includes an operation time condition corresponding to at least one operation included in the valid or invalid operation procedure of said operation data,
said operation inspection unit inspects whether an operation time consumed by the learner matches with the operation time condition as for an operation having the operation time condition, and
said transmission unit transmits to the supervisor terminal apparatus either a match or a mismatch between the consumed operation time and the operation time condition, together with the inspection result.

6. The terminal operation training apparatus according to claim 5, wherein, only when the consumed operation time does not match with the operation time condition, said transmission unit transmits to the supervisor terminal apparatus an indication of the mismatch, together with the inspection result.

7. The terminal operation training apparatus according to claim 1,
wherein said operation inspection unit scores the operations of the learner based on the inspection result, and
said transmission unit further transmits to the supervisor terminal apparatus a result scored by the operation inspection unit.

8. The terminal operation training apparatus according to claim 1, further comprising a reception unit, which receives a remote operation input to the input unit from the supervisor terminal apparatus,
wherein, when the reception unit receives the remote operation input, said input unit inputs said remote operation input, and said display unit visually displays an indication of the remote operation input on the operation screen.

9. The terminal operation training apparatus according to claim 1, wherein said terminal operation training apparatus is incorporated in an operator terminal apparatus used by an operator.

10. The terminal operation training apparatus according to claim 9, wherein said display unit, said input unit, said operation inspection unit, and said transmission unit perform the respective processing in parallel with a customer reception processing by use of the operator terminal apparatus.

11. The terminal operation training apparatus according to claim 1, wherein said display unit displays the inspection result obtained by the operation inspection unit.

12. A terminal operation training method performed in a terminal operation training apparatus for supporting operation training of an operator terminal apparatus for use in receiving customers, said terminal operation training method comprising:
displaying an operation screen of the operator terminal apparatus onto a display unit of the terminal operation training apparatus;
receiving an operation input corresponding to the operation screen, said operation input being input by a learner;
inspecting validity of the operation input by comparing the received operation input with an operation data representing a valid or invalid operation procedure of the operator terminal apparatus, said operation data being stored in a storage unit of the terminal operation training apparatus; and
transmitting the inspection result to an apparatus of a supervisor connected to the terminal operation training apparatus.

13. A program product executed by a computer, said computer being used to support operation training of an operator terminal apparatus for use in receiving customers, said program product comprising:
displaying an operation screen of the operator terminal apparatus onto a display unit of said computer;
receiving an operation input corresponding to the operation screen, said operation input being input by a learner;
inspecting validity of the operation input by comparing the received operation input with an operation data representing a valid or invalid operation procedure of the operator terminal apparatus, said operation data being stored in a storage unit of said computer; and
transmitting the inspection result to an apparatus of a supervisor connected to said computer.

14. A supervisor terminal apparatus for supervising a state of a terminal operation training apparatus used by a learner so as to support operation training of an operator terminal apparatus for use in receiving customers, said supervisor terminal apparatus being connected via a communication line to the terminal operation training apparatus, said supervisor terminal apparatus comprising:
a reception unit, which receives, from the terminal operation training apparatus through the communication line, an inspection result including validity of an operation input by the learner in the terminal operation training apparatus, said validity being obtained by comparing the operation input with an operation data representing a valid or invalid operation procedure of the operator terminal apparatus; and
a display unit, which displays the inspection result received by the reception unit.

15. The supervisor terminal apparatus according to claim 14, further comprising:
an operator screen display unit, which displays an operation screen of the operator terminal apparatus;
an input unit, which inputs an operation corresponding to the operation screen displayed by said operator screen display unit; and
a transmission unit, which transmits the operation input from said input unit to the terminal operation training apparatus.

16. A supervising method performed in a supervisor terminal apparatus for supervising a state of a terminal operation training apparatus used by a learner so as to support operation training of an operator terminal apparatus for use in receiving customers, said supervisor terminal apparatus being connected via a communication line to the terminal operation training apparatus, said supervising method comprising:
receiving, from the terminal operation training apparatus through the communication line, an inspection result including validity of an operation input by a learner in terminal operation training apparatus, said validity being obtained by comparing the operation input with an operation data representing a valid or invalid operation procedure of the operator terminal apparatus; and
displaying the inspection result onto a display unit of said supervisor terminal apparatus.

17. A terminal operation training system having a terminal operation training apparatus and a supervisor terminal apparatus, said terminal operation training apparatus supporting operation training of an operator terminal apparatus for use in receiving customers, said supervisor terminal apparatus supervising said terminal operation training apparatus,
wherein said terminal operation training apparatus comprises:
a storage unit, which stores operation data representing a valid or invalid operation procedure of the operator terminal apparatus;
a display unit, which displays an operation screen of the operator terminal apparatus;
an input unit, which inputs operations of a learner corresponding to the operation screen;
an operation inspection unit, which compares the operations input through said input unit with the operation data and inspects validity of the operations; and
a transmission unit, which transmits an inspection result obtained by said operation inspection unit to the supervisor terminal apparatus connected to said terminal operation training apparatus through a communication line, and
wherein said supervisor terminal apparatus comprises:
a reception unit, which receives the inspection result transmitted from the transmission unit through the communication line; and
a display unit, which displays the inspection result received by the reception unit.
